(19) United States
(12) Patent Application Publication
(10) Pub. No.: US 2009/0070734 A1
(43) Pub. Date: Mar. 12, 2009

(54) SYSTEMS AND METHODS FOR MONITORING SOFTWARE APPLICATION QUALITY

(76) Inventors: Mark Dixon, Beverly, MA (US); Michael Hamilton, Beverly, MA (US)

Correspondence Address: JACOBS & KIM LLP, 1050 WINTER STREET, SUITE 1000, #1082, WALTHAM, MA, 02451-1401, US

(21) Appl. No.: 12/088,116

(22) PCT Filed: Sep. 29, 2006
(86) PCT No.: PCT/US06/37921

§ 371 Date: Sep. 10, 2008

Related U.S. Application Data
(60) Provisional application No. 60/723,283, filed on Oct. 3, 2005.

(51) Int. Cl. G06F 9/44

(52) U.S. Cl. 717/102; 717/126; 717/122

(57) ABSTRACT

Computer-based systems, methods and software products for monitoring software application quality comprise enabling a computer to generate a developer-identifying output identifying which software application developer (301) among a plurality of software application developers is responsible for a given software application modification in a corpus of software application code; analyzing the corpus of software application code to generate a software code quality output comprising values (303-305) for metrics of software code quality; and correlating the developer-identifying output and the software code quality output (306) to produce human-perceptible software application quality reports (309) on a per-developer basis, thereby to provide attribution of quality metric values on a per-developer basis.

### CROSS-REFERENCE AND CLAIM OF PRIORITY

This application for patent claims the benefit of U.S. Provisional Patent Application Ser. No. 60/723,283 filed Oct. 3, 2005 (Attorney Docket TMST-102-PR), entitled “Method and System for Monitoring Software Application Quality,” which is incorporated herein by reference in its entirety.

### FIELD OF THE INVENTION

The present invention relates generally to systems and methods for software development, and in particular, to systems and methods for monitoring software application quality.

### BACKGROUND OF THE INVENTION

Developing a software product is a difficult, labor-intensive process, typically involving contributions from a number of different individual developers or groups of developers. A critical component of successful software development is quality assurance. At present, software development managers use a number of separate tools for monitoring application quality. These tools include: static code analyzers that examine the source code for well-known errors or deviations from best practices; unit test suites that exercise the code at a low level, verifying that individual methods produce the expected results; and code coverage tools that monitor test runs, ensuring that all of the code to be tested is actually executed.

These tools are code-focused and produce reports showing, for example, which areas of the source code are untested or violate coding standards. The code-focused approach is exemplified, for example, by Clover (www.cenqua.com) and CheckStyle (maven.apache.org/maven-1.x/plugins/checkstyle).

In addition, many software teams use a form of product known as a “version control system” to manage the source code being developed. A version control system provides a central repository that stores the master copy of the code. To work on a source file, a developer uses a “check out” procedure to gain access to the source file through the version control system. Once the necessary changes have been made, the developer uses a “check in” procedure to cause the modified source file to be incorporated into the master copy of the source code. The version control repository typically contains a complete history of the application's source code, identifying which developer is responsible for each and every modification. Version control products, such as CVS (www.nongnu.org/cvs) can therefore produce code listings that attribute each line of code to the developer who last changed it.

Present systems, however, cannot correlate information from a version control system with information from application quality monitoring tools. A development manager may attempt to manually cross-check version control information against output from a code quality tool, but the amount of effort required would be prohibitive on any reasonably sized project, and essentially impossible on large projects.

The Apache Maven open-source project (maven.apache.org) claims to integrate the output of different code quality tools. However, while this project appears to provide an easy way to view the separate reports produced by each tool, it does not integrate them in any way.

### SUMMARY OF THE INVENTION

The above-described issues, and others, are addressed by the present invention, aspects of which provide systems and techniques for generating and reporting quality control metrics that are based on the performance of each developer, by combining and correlating information from a version control system with data provided by code quality tools. The described systems and techniques are much more powerful and useful than conventional tools, since they allow a development manager to precisely identify skills deficits and monitor developer performance over time. Thus, the present invention allows a development manager to tie quality control issues to the developer who is responsible for introducing them.

One aspect of the invention involves a computer-executable method for monitoring software application quality, the method comprising generating a developer-identifying output identifying which software application developer among a plurality of software application developers is responsible for a given software application modification in a corpus of software application code; analyzing the corpus of software application code to generate a software code quality output comprising values for metrics of software code quality; and correlating the developer-identifying output and the software code quality output to produce human-perceptible software application quality reports on a per-developer basis, thereby to provide attribution of quality metric values on a per-developer basis.

Another aspect of the invention involves a computer-readable software product executable on a computer to enable monitoring of software application quality, the software product comprising first computer-readable instructions encoded on a computer-readable medium and executable to enable the computer to generate a developer-identifying output identifying which software application developer among a plurality of software application developers is responsible for a given software application modification in a corpus of software application code; second computer-readable instructions encoded on the computer-readable medium and executable to enable the computer to analyze the corpus of software application code to generate a software code quality output comprising values for metrics of software code quality; and third computer-readable instructions encoded on the computer-readable medium and executable to enable the computer to correlate the developer-identifying output and the software code quality output to produce human-perceptible software application quality reports on a per-developer basis, thereby to provide attribution of quality metric values on a per-developer basis.

Further aspects, examples, details, embodiments and practices of the invention are set forth below in the Detailed Description of the Invention.

### BRIEF DESCRIPTION OF THE DRAWINGS

FIG. 1 is a schematic diagram of a conventional digital processing system in which the present invention can be deployed.

FIG. 2 is a schematic diagram of a conventional personal computer, or like computing apparatus, in which the present invention can be deployed.

FIG. 3 is a diagram illustrating a software development monitoring system according to a first aspect of the invention.

FIG. 4 is a flowchart illustrating a technique according to an aspect of the invention for generating a metric based on the number of coding compliance violations attributed to a developer.

FIG. 5 is a flowchart illustrating a technique according to an aspect of the invention for generating a metric based on the unit test coverage of lines of executable source code attributed to a developer.

FIG. 6 is a flowchart illustrating a technique according to an aspect of the invention for generating a metric based on the number of failing unit tests attributed to a developer.

FIGS. 7-9 are a series of screenshots of web pages used to provide a graphical user interface for retrieving and displaying metrics generated in accordance with aspects of the present invention.

FIG. 10 is a diagram illustrating a network configuration according to a further aspect of the present invention.

FIG. 11 is a flowchart illustrating an overall technique according to aspects of the invention.

### DETAILED DESCRIPTION OF THE INVENTION

Today's business software products are measured in millions of lines of code. Thus, it is more important than ever to build quality into a software product from the start, rather than trying to track down bugs later. When code quality starts to slip, deadlines are missed, maintenance time increases, and return on investment is lost.

The present invention provides improved techniques for systems for software development, and in particular, to systems and methods for monitoring software application quality by merging the output of conventional tools with data from a version control system. The described systems and techniques allow a software development manager to attribute quality issues to the responsible software developer, i.e., on a per-developer basis. The following discussion describes methods, structures and systems in accordance with these techniques.

The presently described systems and techniques provide visibility for a quality-driven software process, and provide management with the ability to pinpoint actionable steps that assure project success, to reduce the likelihood of software errors and bugs, to leverage an existing system and tools to measure testing results and coding standards, and to manage geographically dispersed development teams.

Further, the presently described systems and methods aid development teams in delivering projects to specification with reduced coding errors by a target date. Development managers can optimize the performance of their development team, thus minimizing time wasted on avoidable rework, on tracking down bugs, and in lengthy code reviews. Development teams can quantify and improved application quality at the beginning of the development process, when it is easier and most cost-effective to address problems.

In addition, the described systems and techniques provide integrated reporting that allows management to view various quality metrics, including, for example, quality of the project as a whole, quality of each team and groups of developers, and quality of individual developer's work. The described systems and techniques further provide metric reporting that helps management to keep a close watch on unit testing results, code coverage percentages, best practices and compliance to coding standards, and overall quality. The described systems and techniques further provide alerts to standards and coding violations, enabling management to take corrective action. From the present description, it will be seen that the described systems and techniques provide a turnkey solution to quality control issues, including discovery, recommendation, installation, implementation, and training.

It will be understood by those skilled in the art that the described systems and methods can be implemented in software, hardware, or a combination of software and hardware, using conventional computer apparatus such as a personal computer (PC) or equivalent device operating in accordance with, or emulating, a conventional operating system such as Microsoft Windows, Linux, or Unix, either in a standalone configuration or across a network. The various processing means and computational means described below and recited in the claims may therefore be implemented in the software and/or hardware elements of a properly configured digital processing device or network of devices. Processing may be performed sequentially or in parallel, and may be implemented using special purpose or reconfigurable hardware.

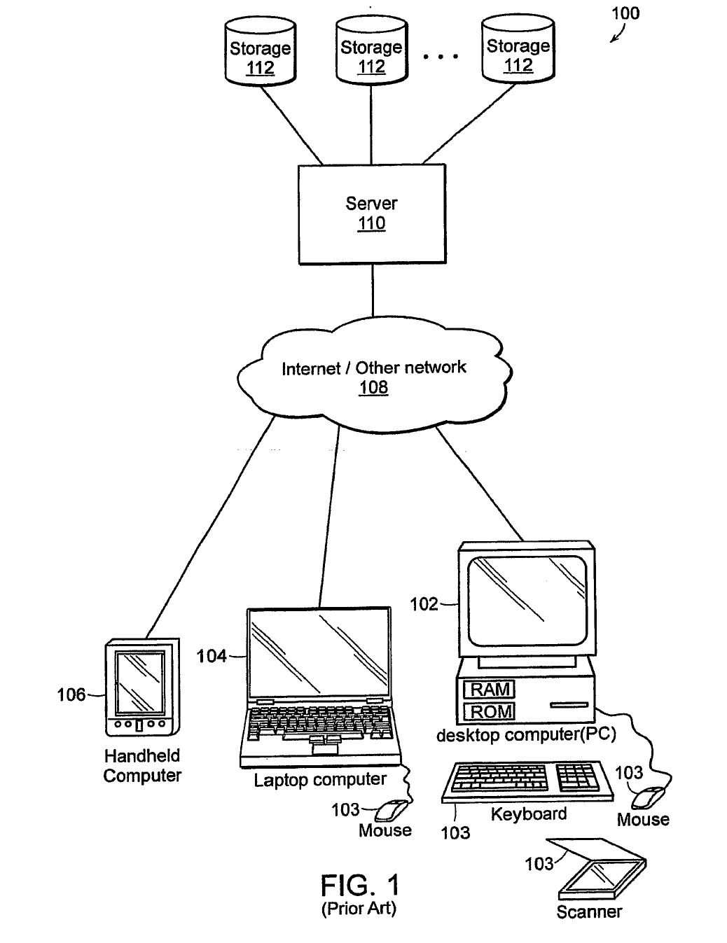

Methods, devices or software products in accordance with the invention can operate on any of a wide range of conventional computing devices and systems, such as those depicted by way of example in FIG. 1 (e.g., network system 100), whether standalone, networked, portable or fixed, including conventional PCs 102, laptops 104, handheld or mobile computers 106, or across the Internet or other networks 108, which may in turn include servers 110 and storage 112.

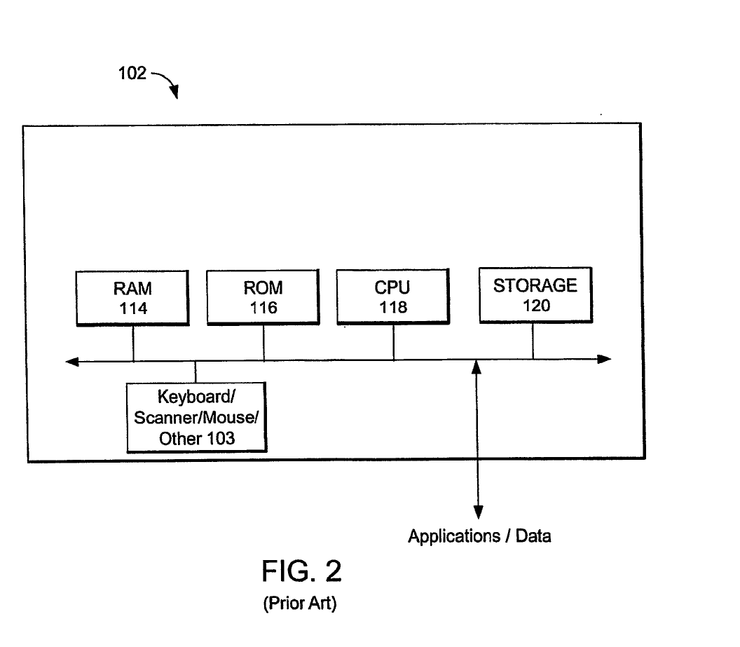

In line with conventional computer software and hardware practice, a software application configured in accordance with the invention can operate within, e.g., a PC 102 like that shown in FIG. 2, in which program instructions can be read from a CD-ROM 116, magnetic disk or other storage 120 and loaded into RAM 114 for execution by CPU 118. Data can be input into the system via any known device or means, including a conventional keyboard, scanner, mouse or other elements 103.

The presently described systems and techniques have been developed for use in a Java programming environment. However, it will be appreciated that the systems and techniques may be modified for use in other environments.

Those skilled in the art will also understand that method aspects of the present invention can be carried out within commercially available digital processing systems, such as workstations and personal computers (PCs), operating under the collective command of the workstation or PC's operating system and a computer program product configured in accordance with the present invention. The term “computer program product” can encompass any set of computer-readable programs instructions encoded on a computer readable medium. A computer readable medium can encompass any form of computer readable element, including, but not limited to, a computer hard disk, computer floppy disk, computer-readable flash drive, computer-readable RAM or ROM element, or any other known means of encoding, storing or providing digital information, whether local to or remote from the workstation, PC or other digital processing device or system. Various forms of computer readable elements and media are well known in the computing arts, and their selection is left to the implementer. In each case, the invention is operable to enable a computer system to calculate a pixel value, and the pixel value can be used by hardware elements in the computer system, which can be conventional elements such as graphics cards or display controllers, to generate a display-controlling electronic output. Conventional graphics cards and display controllers are well known in the computing arts, are not necessarily part of the present invention, and their selection can be left to the implementer.

Those skilled in the art will also understand that the method aspects of the invention described herein could also be executed in hardware elements, such as an Application-Specific Integrated Circuit (ASIC) constructed specifically to carry out the processes described herein, using ASIC construction techniques known to ASIC manufacturers. Various forms of ASICs are available from many manufacturers, although currently available ASICs do not provide the functions described in this patent application. Such manufacturers include Intel Corporation and NVIDIA Corporation, both of Santa Clara, Calif. The actual semiconductor elements of such ASICs and equivalent integrated circuits are not part of the present invention, and will not be discussed in detail herein.

As discussed above, current approaches for monitoring software development focus on the detection and correction of errors in source code. While of course the detection and correction of coding errors is an essential component of quality assurance, focusing only on this aspect of quality assurance limits the ability of a manager to proactively seek out the causes of coding errors and to take steps to reduce the number of future errors.

Although current software development monitoring systems are able to detect errors, these systems are typically not able to provide a manager with an attribution of coding errors to particular team members, or with a meaningful quantification of the magnitude and frequency of the attributed errors. Without this information, it is difficult, if not impossible, for a manager to hold individual team members properly accountable for a high error rate. A general lack of accountability may encourage sloppiness in individual team members and lead to a higher overall error rate. In addition, without this information, it is difficult, if not impossible, for a manger to determine whether a particular quality improvement initiative has had the desired effect, or to measure the progress made by individual team members.

According to an aspect of the invention, a software development environment is analyzed to determine what types of error accountability would be useful for a software manager. Metrics are then developed, in which types of errors are assigned to team members. As used herein, the terms “developer” or “team member” may refer to an individual software developer, to a group of software developers working together as a unit, or to other groupings or working units, depending upon the particular development environment.

According to a further aspect of the invention, an automatic system monitors errors occurring during the development process, and metrics are generated for each developer. The metrics are then combined into a “dashboard” display that allows a software manager to quickly get an overall view of the errors attributed to each team member. In addition, the dashboard display provides composite data for the entire development team, and also provides trend information, showing the manager whether there has been any improvement or decline in the number of detected errors.

As part of the system, each type of error is assigned to a particular team member. A particular source code file may reflect the contribution of a plurality of team members. Thus, the present invention provides techniques for determining which team member is the one to whom a particular type of error is to be assigned. The systems and techniques described herein provide flexibility, allowing different types of errors to be assigned to different developers.

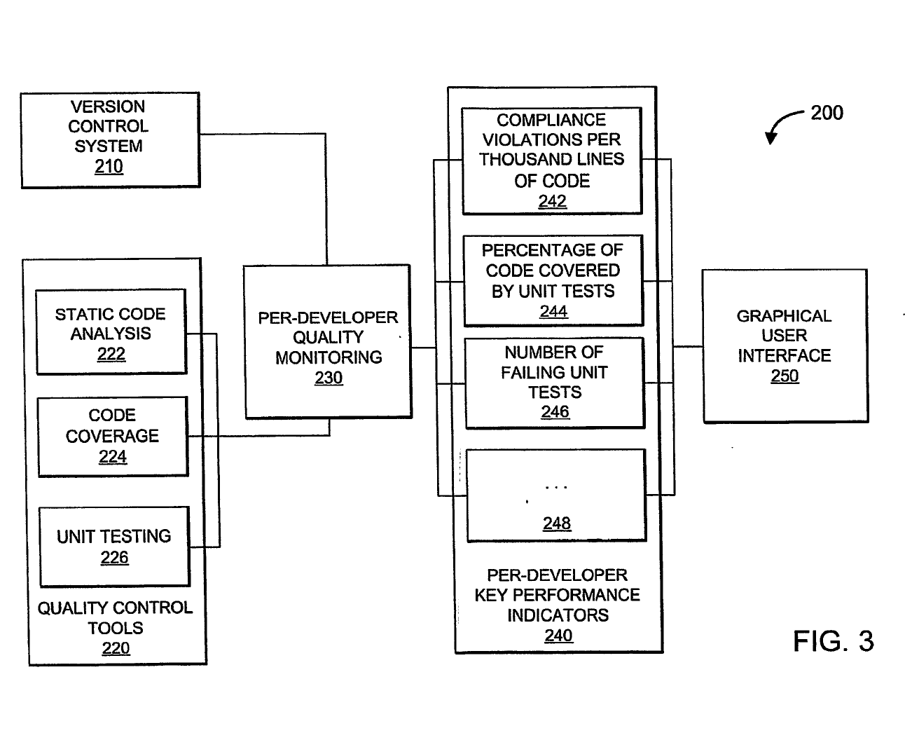

FIG. 3 shows a diagram of the software components of a system 200 according to an aspect of the invention. The system 200 includes a version control system 210, a set of quality control tools 220, and a per-developer quality monitoring module 230. In the presently described system 200, the set of quality control tools 220 includes a static code analysis tool 222, a code coverage tool 224, and a unit testing tool 226. It will be appreciated from the present description that the system 200 may be modified to include other types of quality control tools 220. In the presently described system 200, the version control system 210 and the quality control tools 220 may be implemented using generally available products, such as those described above.

The per-developer quality monitoring module 230 is configured to receive data from the version control system 210 and each of the quality control tools 220 and integrates that data to generate per-developer key performance indicators (KPIs) 240 that are stored in a suitable repository, such as a network-accessible relational database. In the presently described system 200, these per-developer KPIs include compliance violations per thousand lines of code 242, percentage of code covered by unit tests 244, and number of failing unit tests 246. These KPIs are described in further detail below. As indicated by box 248, other KPIs may also be included.

System 200 further includes a graphical user interface (GUI) 250 that provides a development manager or other authorized user with access to the per-developer KPIs 240. As described below, according to a further aspect of the invention, the GUI 250 is implemented in the form of a set of web pages that are accessed at a PC or workstation using a standard web browser, such as Microsoft Internet Explorer, Netscape Navigator, or the like.

The per-developer quality monitoring module 230 is designed to be configurable, such that the system 200 can be adapted for use with version control systems 210 and quality control tools 220 from different providers. Thus, a software manager can incorporate aspects of the present invention into a currently existing system, with its currently installed version control system 210 and quality control tools 220.

The quality monitoring module 230 is operable to periodically communicate with the version control subsystem 210 for updates to application source code, and, when changes are detected, to download revised code, re-calculate quality metrics 240, and store the results in a relational database.

The present description focuses on three KPI metrics, by way of example. The three described metrics are: compliance violations per thousand lines of source code 242; percentage of code covered by unit tests 244; and number of failing unit tests 246. However, those skilled in the art will recognize that the techniques discussed herein are generally applicable. Each metric is described in turn.

(a) Compliance Violations per Thousand Lines of Source Code

An aspect of the invention provides a technique that generates for each team member a metric 242 based upon the number of compliance violations assigned to that team member, based upon established criteria. Generally speaking, of course, it is desirable for a team member to have as few compliance violations as possible.

Compliance violations are error messages reported by static code analyzer 222. An example of a commonly used static code analyzer is the open-source tool CheckStyle, mentioned above. Currently available static code analyzer products typically generate detailed data for each compliance violation, including date and time of the violation, the type of violation, and the location of the source code containing the violation.

The present aspect of the invention recognizes that there are many different types of compliance violations, having differing degrees of criticality. Some compliance violations, such as program bugs, may be urgent. Other compliance violations, such as code formatting errors, may be important, but less urgent. Thus, according to the presently described technique, compliance violations are sorted into three categories: high priority, medium priority, and low priority. If desired, further metrics may be generated by combining two or more of these categories, or by modifying the categorization scheme. Also, in the presently described technique, every single code violation is assigned to a designated team member. However, if desired, the technique may be modified by creating one or more categories of code violations that are charged to the team as a whole, or that are not charged to anyone.

The present aspect of the invention further recognizes that larger projects tend to have more compliance violations than smaller projects. Thus, in order to allow for effective comparison of metrics between projects, the number of violations is divided by the total number of lines of source code.

In developing an effective metric according to the present invention, it is necessary to assign each code violation to a team member. In the presently described technique, each code violation is assigned to a single team member. However, if desired, the technique may be modified to allow a particular code violation to be charged to a plurality of team members.

As mentioned above, the version source control system 210 includes a repository containing a complete history of the application's source code, identifying which developer is responsible for each and every modification. The version control system 210 therefore produces code listings that attribute each line of code to the developer that last changed it. The currently described technique and system use the data generated by version control system 210 and static code analysis tool 222 to assign each code violation to a member of the development team.

One issue in assigning code violations to team members is that compliance violations are not always attributable to a single line of source code. Thus, according to an aspect of the invention, violations are assigned to a developer by attributing every single violation in a given source file to the most recent developer to modify that file. This approach generally comports well with the industry practice of requiring each developer, at check-in, to submit code to the version control system with no coding violations, even if the developer is thereby required to fix pre-existing violations, i.e., violations that may have arisen due to coding errors by other team members.

As mentioned above, according to a further aspect of the invention, the number of errors assigned to a team member is divided by a total number of lines of source code assigned to that team member. One technique that can be used to assign a number of lines of source code to a team member is to calculate the sum of the size, measured in lines, of each of the source files that were last modified by that developer.

A second, simpler technique uses a count, for each team member, of the total number of actual lines of source code that were last modified by that team member. Thus, if a developer has modified one line in a 10-line file, the first technique would assign ten lines of code to the developer, whereas the second technique would assign only one line of code to the developer.

It will be seen that the first technique would be expected to provide a more useful metric, because it takes into account the size of the source code file modified by a given developer. A single code violation would typically be much more significant in a 10-line source code file than it would be in a 100-line source file.

However, it will be appreciated that the systems and techniques described herein may also be practiced employing different techniques for assigning a number of lines of code to a given developer.

For convenient reference, the system calculates the number of compliance violations per thousand lines of code. However, depending upon the particular scaling requirements of a particular development environment, a number of lines of code other than one thousand may be used.

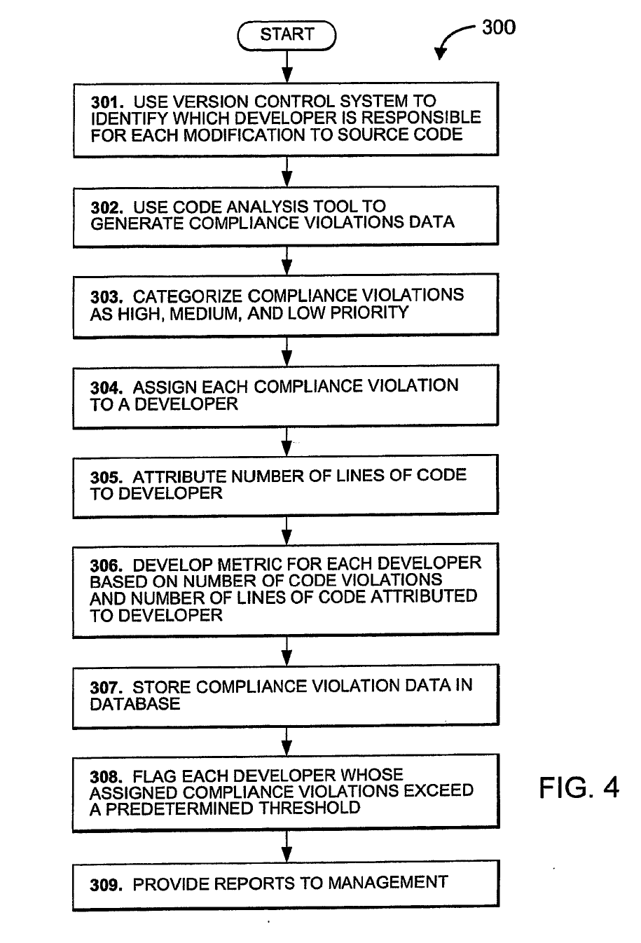

FIG. 4 shows a flowchart of a method 300 in accordance with the technique described above. In step 301, version control system is used to identify which developer is responsible for each modification to the source code. In step 302, a code analysis tool is used to generate compliance violations data. In step 303, the compliance violations are categorized as high, medium, and low priority. In step 304, each compliance violation is assigned to a developer. In step 305, a number of lines is attributed to each developer. In step 306, a metric is developed for each developer based on the number of code violations and the number of lines of code attributed to the developer. In step 307, the resulting compliance violation data is stored in a database. In step 308, each developer is flagged, whose assigned compliance violations exceed a predetermined. In step 309, reports are provided to management.

(b) Percentage of Code Covered by Unit Tests

Another useful metric that has been developed in conjunction with the techniques and systems described herein is a metric 244 based on the unit test coverage of source code assigned to a particular developer.

As mentioned above, a unit test suites is a software package that is used to create and run tests that exercise source code at a low level to help make sure that the code is operating as intended. Of course, in an ideal situation, every single line of executable code in a software product being developed would be covered by a unit test. However, for a number of reasons, this is not always possible. Where 100% unit test coverage is not achievable, a software development team typically operates under established unit test coverage guidelines. For example, management may set a minimum threshold percentage, a target percentage, or some combination thereof. Other types of percentages may also be defined.

In a technique and system according to the invention, data generated by code coverage tool 224 and version control system 210 are used to determine for each member of a development team: (1) number of lines of executable code assigned to the team member; and (2) of those lines of executable code, how many lines are covered by unit tests. In the presently described technique and system, these quantities are divided to produce a percentage. It will be appreciated that the described techniques and systems may be used with other types of quantification techniques.

According to the present aspect of the invention, blank lines, comment lines and the like are excluded from the coverage percentage. Thus, the coverage percentage may theoretically range from 0% all the way up to 100% coverage is theoretically possible. In practice, values of 60%-80% are usually set as minimum acceptable coverage thresholds.

The present aspect of the invention provides a report indicating which of the following categories each line of source code belongs to: (1) executable and covered; (2) executable, but not covered; or (3) non-executable (and therefore not testable). For the project as a whole, the metric 244 is defined to be the number of covered lines divided by the number of executable lines. The line ownership information from the source code control system is used to assign every executable line to a developer. Thus, the described metric can be calculated on a per-developer basis.

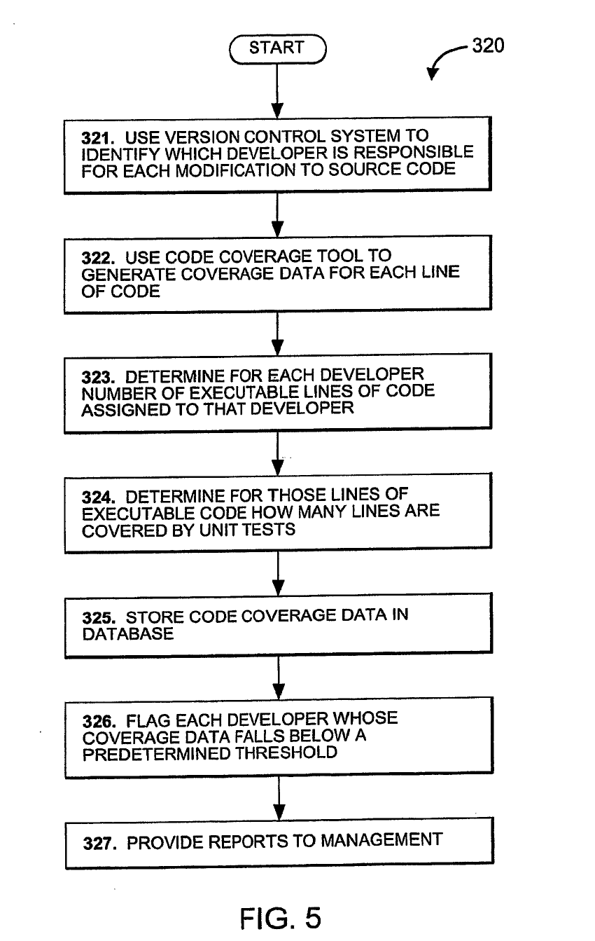

FIG. 5 shows a flowchart of a method 320 in accordance with the above described systems and techniques. In step 321, a version control system is used to identify which developer is responsible for each modification to the source code. In step 322, a code coverage tool is used to generate coverage data for each line of code. In step 323, there is determined for each developer the number of executable lines of code assigned to that team member. In step 324, there is determined for those lines of executable code how many lines are covered by unit tests. In step 325, the code coverage data is stored in a database. In step 326, each developer is flagged, whose coverage data falls below a predetermined threshold. In step 327, reports are provided to management.

(e) Number of Failing Unit Tests

In a healthy development project all unit tests should pass at all times and so any failing unit tests, as indicated by unit testing tool 226, represent a problem with the code requiring immediate attention. In conventional practice, metrics relating to failing unit tests are traditionally defined for a project as a whole. According to a further aspect of the invention, a technique has been developed for computing a failing test metric 246 on an individual developer basis.

As mentioned above, at any point in time, a typical source code control system can report on which developer last modified every single line of source code in the system along with the exact date and time of that modification. Assigning a failing unit test to a specific developer is a challenging problem, since a unit test may fail because of a change in the test, a change in the class being tested or a change in some other part of the system that impacts the test. The approach taken in the practice of the invention described herein, while not foolproof, provides a reasonable answer that is efficient to compute and provides a useful approximation.

Typically, a unit testing tool 226 does not dictate a particular relationship between a unit test and a class being tested. However, it is common practice in the software industry for a unit test to be named after the class under test, with the character string “Test” appended thereto. Thus, the first attempts to take advantage of this convention to attempt to determine the class under test, by looking at the name assigned to the unit test. If the class can be determined, the failure is attributed to the most recent developer to modify the class, as indicated by version control system 210. If the class cannot be determined, the failure is attributed to the most recent developer to modify the unit test class itself.

According to a further aspect of the invention, a more accurate attribution is possible for failing unit tests if the metrics are recomputed after every individual check-in to the version control system 210. Every check-in is associated with a single developer, and thus, if a test had been passing, but is now failing, then the failure must be the responsibility of the developer who made the last check-in. However, re-computing metrics on every check-in is not feasible for large projects with a high number of check-ins per day.

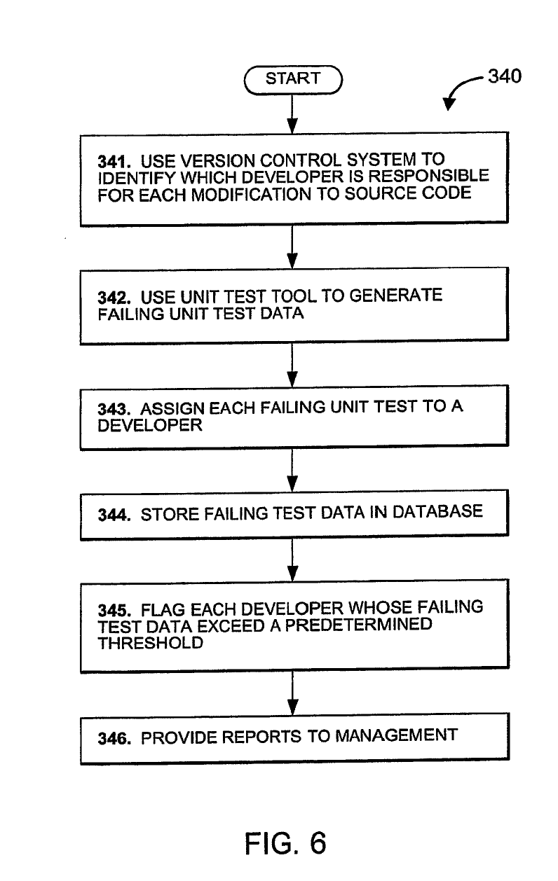

FIG. 6 shows a flowchart of a method 340 in accordance with the above-described systems and techniques. In step 341, a version control system is used to identity which developer is responsible for each modification to the source code. In step 342, a unit test tool is used to generate failing unit test data. In step 343, each failing unit test is assigned to a developer. In step 344, failing test data is stored in a database. In step 345, a developer is flagged, if their failing test data exceeds a predetermined threshold. In step 346, reports are provided to management.

A further aspect of the invention provides a useful graphical user interface (GUI) that allows a software development management to get a quick overview of the various metrics described above. It will be appreciated that different schema may be used for displayed metrics, as desired.

As mentioned above, the KPI metrics 240 generated by the quality monitoring system 230 are provided to a manager, or other end user, using a GUI 250 comprising a set of web pages that are accessible at a workstation or personal computer using a suitable web browser, such as Microsoft Internet Explorer or Netscape Navigator.

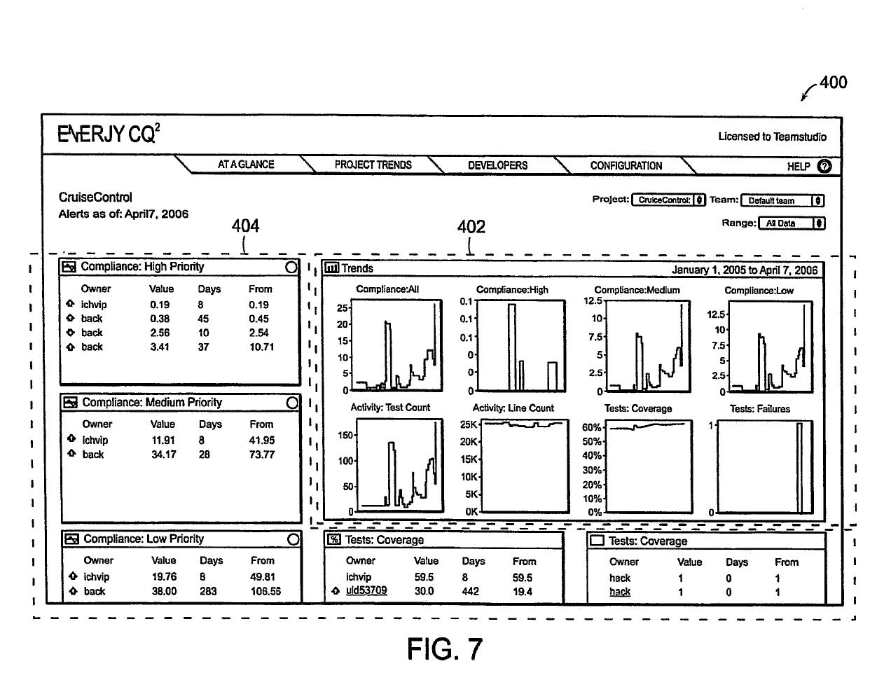

FIG. 7 shows a screenshot an overview page 400 for the above-described metrics that can be generated in accordance with the present invention. The small graphs 402 therein show the recent behavior of the key quality metrics described above for the development team as a whole. The five tables 404, to the left and bottom of the screen, display alerts for any individual developers who have exceeded a prescribed threshold for a metric. Each of the five tables 404 shows the name of the developer, the value of the relevant metric, the number of days that the alert has been firing and the value of the metric when the alert first fired.

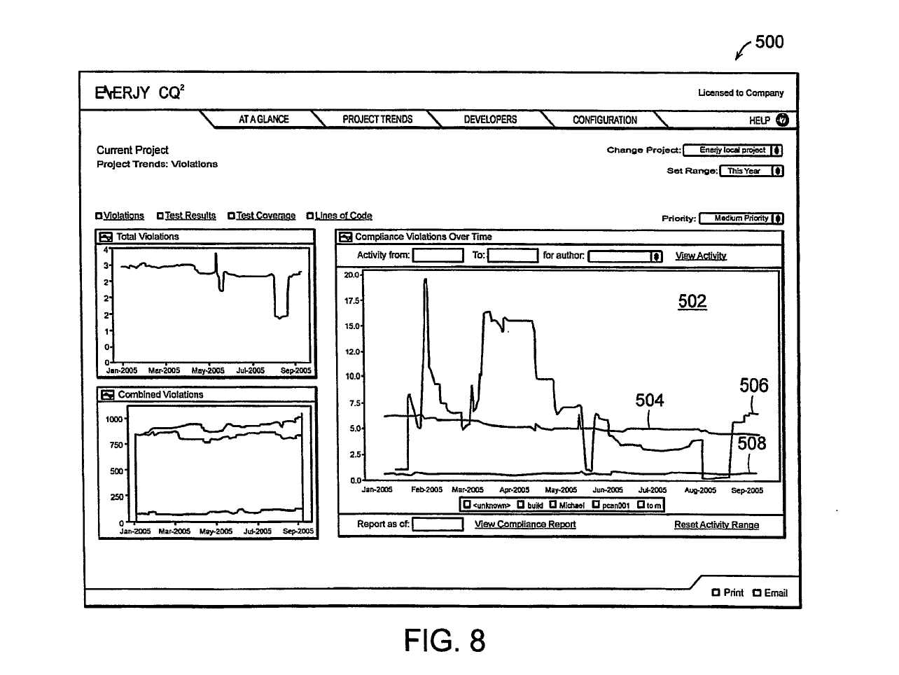

FIG. 8 is a screenshot of a “project trends” page 500 showing a greater level of detail for specific -metrics, in this case, “Medium Priority Compliance Violations.” The large graph 502 in FIG. 8 shows the performance of each developer on the team over time. In this case, for example, the graph includes a plot 504 indicating that developer “tom” has a high number of violations but has made progress toward reducing the number over the past year. Developer “pcarr001” has a rather erratic plot 506; this developer owns relatively little code and thus a small change in the number of violations can have a large effect on the metric. Developer “Michael” has a plot 506 showing very well for this metric, but that is beginning to trend upwards towards the end of the time range.

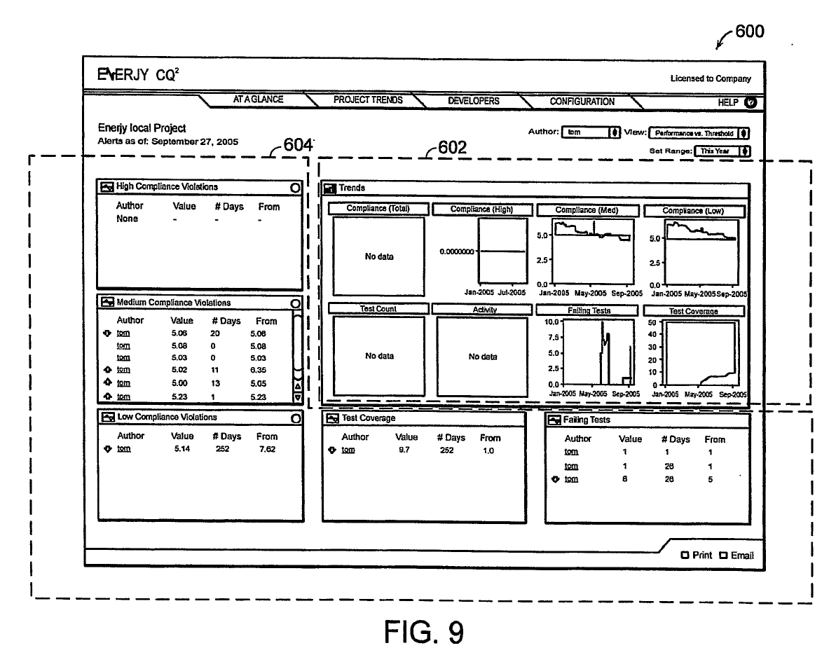

FIG. 9 shows a “developers” page 600 that can be used to help assess the performance of developer over a span of time. The small graphs 602 show, for a selected developer, the performance against threshold for each of the five key quality metrics. Deviations from the threshold are shown in color: red for failing to meet the required standard, green for exceeding the standard. The five tables 604 at the left and bottom show all alerts that the selected developer generated over the time period.

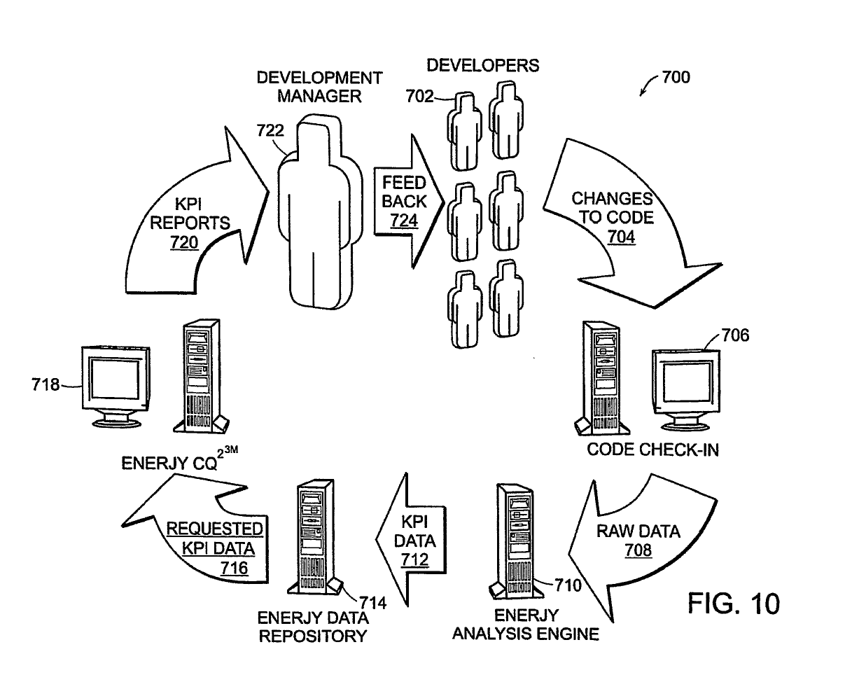

FIG. 10 shows an information flow diagram of a network configuration 700 in accordance with a further aspect of the invention. A team of developers 702 makes changes to code 704 that are then submitted for check-in at a local workstation 706. At check-in, the submitted code is processed by quality control tools, such as a static code analysis tool, a coverage tool, and a unit testing tool, as described above, thereby generating raw data 708 that is provided to an analysis engine 710, which in FIG. 10 is illustrated as being a server-side application. The analysis engine 710 then processes the data 708, as described above, converting the data 708 into key performance indicator (KPI) data 712, which is stored in a relational database in a suitable data repository 714. The data repository 714 then provides requested KPI data 716 to a manager workstation 718 running a suitable client-side application. The manager workstation 718 provides KPI reports 720 to a development manager 722, who can then use the reported data to provide feedback 724 to the development team 702, or take other suitable actions.

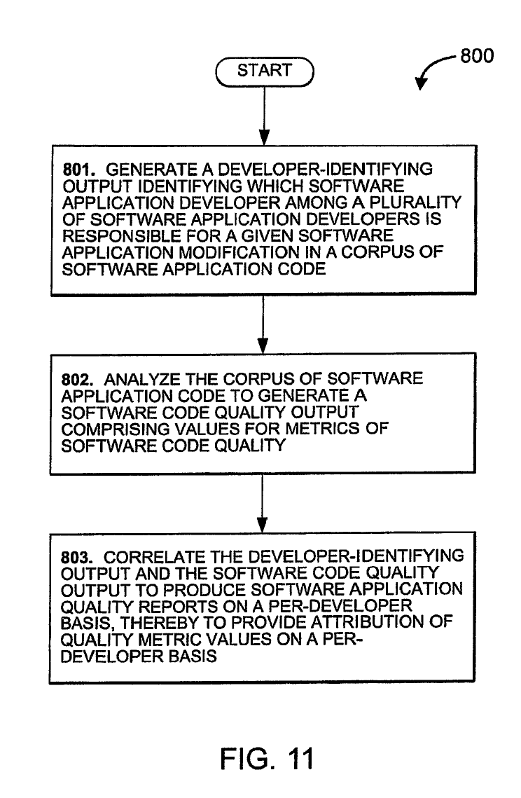

FIG. 11 shows a flowchart of an overall technique 800 according to aspects of the invention. In step 801, a developer-identifying output is generated that identifies which software application developer among a plurality of software application developers is responsible for a given software application modification in a corpus of software application code. In step 802, the corpus of software application code is analyzed to generate a software code quality output comprising values for metrics of software code quality. In step 803, the developer-identifying output and the software code quality output are correlated to produce software application quality reports on a per-developer basis, thereby to provide attribution of quality metric values on a per-developer basis.

From the present description, it will be seen that aspects of the invention, as described herein, provide a number of benefits, including the following:

First, the described systems and techniques reduce the likelihood of software errors and bugs in code. Specifically, the present invention helps to identify problems before a project enters into production, to ensure that all code is exercised through testing, and to enforce coding standards.

Further, the described systems and techniques help to pinpoint actionable steps that assure project success, providing early identification of performance issues and action items, in order to address the progress and behaviors of individual team members.

In addition, the described systems and techniques reduce high ongoing maintenance costs. Maintenance, such as adding new features, will take less time because code that is written to standard with thorough unit tests is easier to comprehend and extend.

The described systems and techniques also help to ensure productivity of team and meet project deadlines. Managers receive a singular report containing action items for improved team management. In addition, managers are able to continuously enforce testing and standards compliance throughout entire development phase.

The described systems and techniques help to manage remote or distributed teams. Specifically, management can monitor the productivity and progress of development teams in various geographical locations and raise all developers to code at the same standards.

Further, the described systems and techniques provide for self-audit and correction. Developers can review and correct errors and code quality problems before handing code over to management for review.

Those skilled in the art will recognize that the foregoing description and attached drawing figures set forth implementation examples of the present invention, and that numerous additions, modifications and other implementations of the invention are possible and are within the spirit and scope of the present invention.

1. A computer-executable system for monitoring software application quality, the system comprising:
a version control subsystem operable to generate an output identifying which software application developer among a plurality of software application developers is responsible for a given software application modification in a corpus application software;
a software code quality monitoring subsystem to generate an output comprising values for metrics of software code quality; and
an analysis module operable to correlate the version control system output and the software code quality monitoring system output to produce software application quality reports on a per-developer basis, thereby to provide attribution of quality metric values on a per-developer basis.

2. The system of claim 1 wherein the software code quality monitoring subsystem comprises a static code analyzer module operable to examine source code for errors or deviations from defined best practices.

3. The system of claim 1 wherein the software code quality monitoring subsystem comprises a unit test suite module operable to execute code under test.

4. The system of claim 3 wherein the software code quality monitoring subsystem comprises a code coverage module operable to monitor test runs, ensuring that code to be tested is actually executed during test runs.

5. The system of claim 1 wherein the version control subsystem comprises an information repository operable to store a master copy of the code and a history of source code associated with a given software application, identifying which developer is responsible for each modification.

6. The system of claim 5 wherein the version control subsystem is further operable to generate a report of which developer last modified each line of source code along with a date and time of each modification.

7. The system of claim 5 wherein the software code quality monitoring subsystem is operable to generate outputs comprising values for a plurality of metrics of software code quality.

8. The system of claim 7 wherein the metrics of software code quality comprise any of compliance violations per thousand lines of source code, percentage of code covered by unit tests, and number of failing unit tests.

9. The system of claim 8 further wherein processing of violations per thousand lines of source code comprises assigning violations to a developer by attributing all of the violations in a source file to the developer who most recently modified that source file.

10. The system of claim 9 further wherein the number of lines of source code per developer is calculated by summing the size, measured in lines, of each of the source files that were last modified by that developer.

11. The system of claim 9 further wherein processing of the percentage of code covered by unit tests metric includes reporting, for each line of source code, whether it is executable and covered, executable but not covered, or not executable.

12. The system of claim 11 further wherein the percentage of code covered by unit tests metric is defined for a software code development project as the number of covered lines divided by the number of executable lines.

13. The system of claim 12 wherein line ownership information obtained from the version control subsystem is utilized to assign every executable line to a given developer, so that the percentage of code covered by unit tests metric can be calculated on a per-developer basis.

14. The system of claim 8 wherein the analysis module is operable to assign a failing unit test to a developer, the assigning comprising:
automatically attempting to determine, utilizing the name of the unit test, the class under test which is associated with the unit test;
if the class under test can be determined, attributing the failing unit test to the developer who most recently modified the class; and
if the class under test cannot be determined, attributing the failing with test to the developer who most recently modified the unit test class itself.

15. The system of claim 14 wherein the analysis module is operable to cause re-computing of metrics after each individual check-in to the source code control system, wherein each check-in is associated with a single developer, such that that a given failure can be attributed to the developer who executed the last check-in.

16. The system of claim 14 further comprising a GUI operable to display a user-perceptible output graphically depicting values calculated for the quality metrics.

17. The system of claim 16 wherein the displaying comprises displaying metrics for an entire development team and alerts for individual developers who have exceeded a prescribed threshold for a metric, the alerts including the name of the developer, the value of the relevant metric, the number of days the alert has been firing and the value of the metric when the alert first fired.

18. The system of claim 17 wherein the GUI is further operable to display progress over time for given developers with respect to selected software code quality metrics.

19. The system of claim 1 further wherein the analysis module is operable to periodically communicate with the version control subsystem for updates to application source code, and, when changes are detected, to download revised code, re-calculate quality metrics, and store the results in a relational database.

20. The system of claim 19 further wherein the GUI comprises a network-based application operable to read data from the relational database.

21. A computer-executable method for monitoring software application quality, the method comprising:
generating a developer-identifying output identifying which software application developer among a plurality of software application developers is responsible for a given software application modification in a corpus of software application code;
analyzing the corpus of software application code to generate a software code quality output comprising values for metrics of software code quality; and
correlating the developer-identifying output and the software code quality output to produce human-perceptible software application quality reports on a per-developer basis, thereby to provide attribution of quality metric values on a per-developer basis.

22. A computer-readable software product executable on a computer to enable monitoring of software application quality, the software product comprising:
first computer-readable instructions encoded on a computer-readable medium and executable to enable the computer to generate a developer-identifying output identifying which software application developer among a plurality of software application developers is responsible for a given software application modification in a corpus of software application code;
second computer-readable instructions encoded on the computer-readable medium and executable to enable the computer to analyze the corpus of software application code to generate a software code quality output comprising values for metrics of software code quality; and
third computer-readable instructions encoded on the computer-readable medium and executable to enable the computer to correlate the developer-identifying output and the software code quality output to produce human-perceptible software application quality reports on a per-developer basis, thereby to provide attribution of quality metric values on a per-developer basis.
